(19) United States
(12) Patent Application Publication
(10) Pub. No.: US 2008/0003398 A1
(43) Pub. Date: Jan. 3, 2008

(54) FOAM CORE CEMENT SHUTTER

(75) Inventor: J. Richard Logan, Oxford, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: TAPCO INTERNATIONAL CORPORATION, Wixom, MI (US)

(21) Appl. No.: 11/767,075

(22) Filed: Jun. 22, 2007

Related U.S. Application Data
(60) Provisional application No. 60/806,177, filed on Jun. 29, 2006.

(51) Int. Cl. B32B 3/00

(52) U.S. Cl. 428/71; 264/241; 425/500

(57) ABSTRACT

A shutter assembly having a foam insert or core enveloped by a cementitious shell is disclosed. The shell can also be provided with an optional hanger member that allows the shutter assembly to be mounted to a dwelling via a bracket affixed to an exterior wall surface thereof. The assembly is molded from a cementitious slurry including gypsum cement and water. An appropriate amount of the slurry is added onto a bottom mold surface portion to a desired depth. If the hanger member is to be used, it is placed onto the bottom mold surface portion prior to the introduction of the slurry. The foam insert or core is placed atop the slurry in a desired orientation, whereupon the top mold surface portion is closed over the bottom mold surface portion. After curing, the shutter assembly is removed from the mold and is ready for immediate use and/or further processing.

### CROSS-REFERENCE TO RELATED APPLICATION

The instant application claims priority to U.S. Provisional Patent Application Ser. No. 60/806,177, filed Jun. 29, 2006, the entire specification of which is expressly incorporated herein by reference.

### BACKGROUND OF THE INVENTION

1. Field of the Invention

The subject invention relates to shutter assemblies and more specifically to shutter assemblies formed from cementitious slurries.

2. Description of the Related Art

Many different modern building designs take advantage of modular shutters for purely aesthetic purposes to decorate exterior windows. The modular shutter assemblies are generally an assembly of plastic parts that are individually formed and then secured together in a cost effective manner. The different plastic parts can be formed by different plastic fabrication techniques such as injection molding and extrusion. The plastic parts are secured together by appropriate fastening mechanisms, such as screws, adhesives, and/or the like, in a manner that is well understood in the art.

Because the shutters are employed for purely aesthetic purposes, it is important to choose an appropriate shutter style that complements, rather than detracts from, the exterior wall surface of the building onto which it is to be mounted. In this respect, certain buildings, especially upscale residential and commercial buildings having stucco, stone, and/or brick exterior walls, are generally not enhanced by the use of plastic, or even metallic, shutters, regardless of the quality and/or cost thereof. That is, the use of a plastic or metallic shutter does not, from an aesthetic viewpoint, coordinate very well with a building having stucco, stone, and/or brick exterior walls.

Additionally, it has been problematic to install shutter assemblies to the building's exterior walls without having to drill large and deep holes therein to accommodate screws that hold the shutter assemblies securely in place. These holes provide ingress for water, dirt, insects, and/or the like that could damage the wall or other surrounding structures. Toward this end, certain municipalities have enacted regulations on if, and how, holes can or cannot be provided in exterior walls for any purpose, including the hanging of shutter assemblies.

Therefore, it would be advantageous to provide shutter assemblies that overcome at least one of the aforementioned problems.

### SUMMARY OF THE INVENTION AND ADVANTAGES

The subject invention provides a shutter assembly having a foam core enveloped by a cement or cementitious exterior shell. The cementitious shell can also be provided with an optional hanger member that allows the shutter assembly to be mounted to a dwelling, e.g., via a bracket affixed to an exterior wall surface thereof. The shutter assembly is formed in a closed mold from a cementitious slurry comprising gypsum cement (e.g., white or grey Portland cement) and water. The slurry can also contain other materials such as but not limited to reinforcement materials (e.g., fibers), as well as other materials that are known in the art (e.g., plasticizers and/or the like). An appropriate amount of the cementitious slurry is added onto a bottom mold surface portion to a desired depth. If the optional hanger member is to be used, it would preferably be placed onto the bottom mold surface portion prior to the introduction of the cementitious slurry. The foam core is then placed atop the cementitious slurry in a desired orientation, the mold is vibrated and pressure is applied to close the mold to a predetermined thickness, such that the top mold surface portion is brought into contact with the bottom mold surface portion. After an appropriate curing or drying time, the shutter assembly is removed from the mold and is ready for immediate use and/or further processing, such as but not limited to painting and/or the like.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a front elevational view of a dwelling having a plurality of shutter assemblies mounted thereto, in accordance with a first embodiment of the present invention;

FIG. 2 is a front elevational view of a louvered shutter, in accordance with a second embodiment of the present invention;

FIG. 3 is a front elevational view of a plain panel shutter, in accordance with a third embodiment of the present invention;

FIG. 4 is a front elevational view of a batten shutter, in accordance with a fourth embodiment of the present invention;

FIG. 5 is a perspective view of a batten shutter, in accordance with a fifth embodiment of the present invention;

FIG. 6 is a partial sectional view taken along line 6-6 of FIG. 5, in accordance with a sixth embodiment of the present invention;

FIG. 7 is a sectional view taken along line 7-7 of FIG. 5, in accordance with a seventh embodiment of the present invention;

FIG. 8 is an exploded view of a molding system for forming a shutter assembly, in accordance with an eighth embodiment of the present invention;

FIG. 9 is a perspective view of a bottom molding member on a conveyor system, in accordance with a ninth embodiment of the present invention;

FIG. 10 is an exploded view of a mold surface member and the bottom molding member on the conveyor system depicted in FIG. 9, in accordance with a tenth embodiment of the present invention;

FIG. 11 is a perspective view of the mold surface member and the bottom molding member on the conveyor system depicted in FIG. 10, in accordance with an eleventh embodiment of the present invention;

FIG. 12 is a perspective view of a cementitious slurry being added onto the mold surface member depicted in FIG. 11, in accordance with a twelfth embodiment of the present invention;

FIG. 13 is a perspective view of the cementitious slurry having been added to a desired depth onto the mold surface member depicted in FIG. 12, in accordance with a thirteenth embodiment of the present invention;

FIG. 14 is a perspective view of a foam insert and an optional hanger member being placed onto the cementitious slurry depicted in FIG. 13, in accordance with a fourteenth embodiment of the present invention;

FIG. 15 is a perspective view of the foam insert and an optional hanger depicted in FIG. 14 being substantially enveloped by the cementitious slurry, in accordance with a fifteenth embodiment of the present invention;

FIG. 16 is a perspective view of the upper mold member being brought into contact with the lower mold member depicted in FIG. 15, in accordance with a sixteenth embodiment of the present invention;

FIG. 17 is an exploded view of the mold surface member being removed from the lower mold member depicted in FIG. 16, in accordance with a seventeenth embodiment of the present invention; and

FIG. 18 is an exploded view of the shutter assembly being removed from the mold surface member depicted in FIG. 17, in accordance with an eighteenth embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

Referring to the Figures, a shutter assembly is generally disclosed at 10. By “assembly,” as that term is used herein, it is meant at least one shutter member.

The shutter assembly 10 can be mounted, either permanently or temporarily to a dwelling 12, such as a residential or commercial building, especially one that includes a stucco, stone, cement, and/or brick exterior. FIG. 1 shows an exterior front view of a house 12 that includes two lower story front windows 14a, 14b, respectively, positioned on opposite sides of a door 16 and an upper story front window 18. Positioned on both sides of each of the windows 14a, 14b, 18, respectively, is a shutter assembly 10. The shutter assemblies 10 are rigidly secured to a front wall of the house 12 by appropriate securing devices, to be described herein, at a location that aesthetically accents the windows 14a, 14b, 18, respectively.

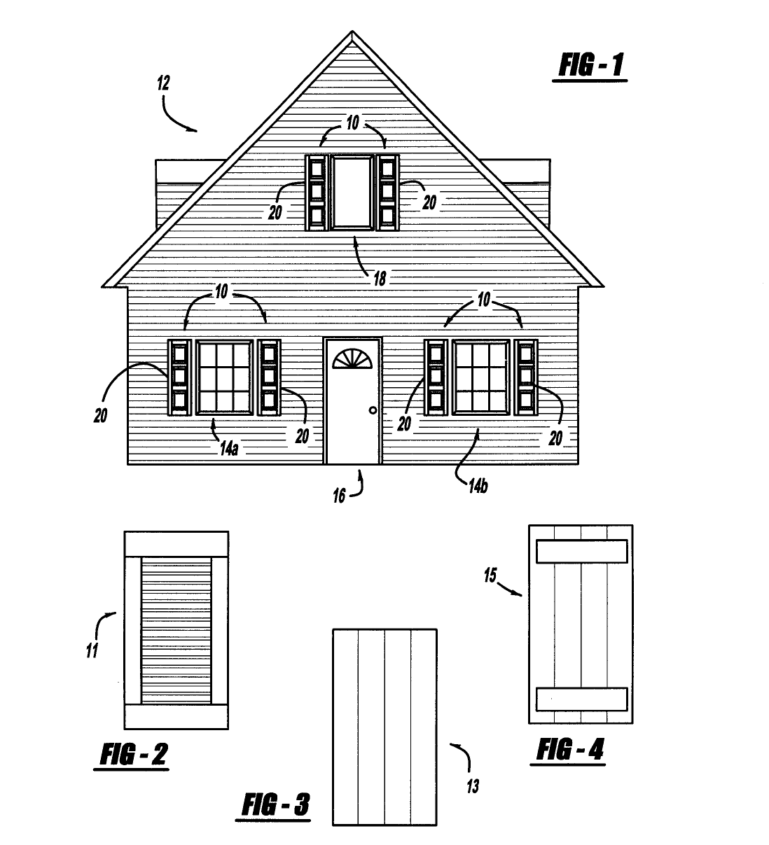

Although raised/recessed panel shutter members are shown in connection with the shutter assemblies 10 in FIG. 1, it should be appreciated that various other configurations of the shutter assembly 10 can be employed with the practice of the present invention. With specific reference to FIGS. 2-4, the shutter assemblies 10 of the present invention can include, without limitation, a louvered shutter member 11, a flat panel shutter member 13, a batten shutter member 15, and/or the like.

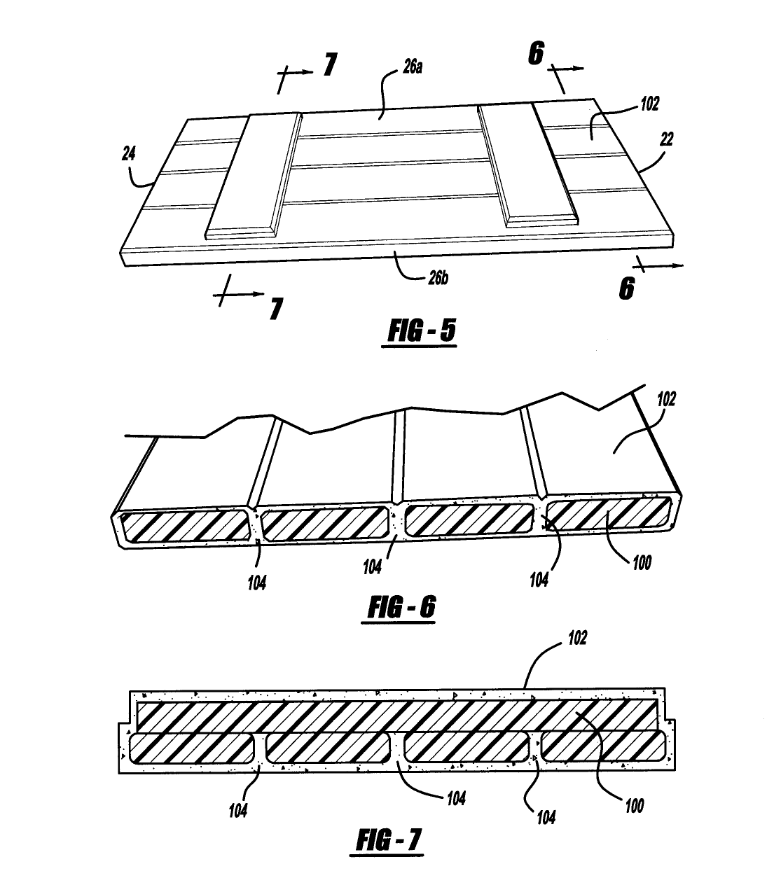

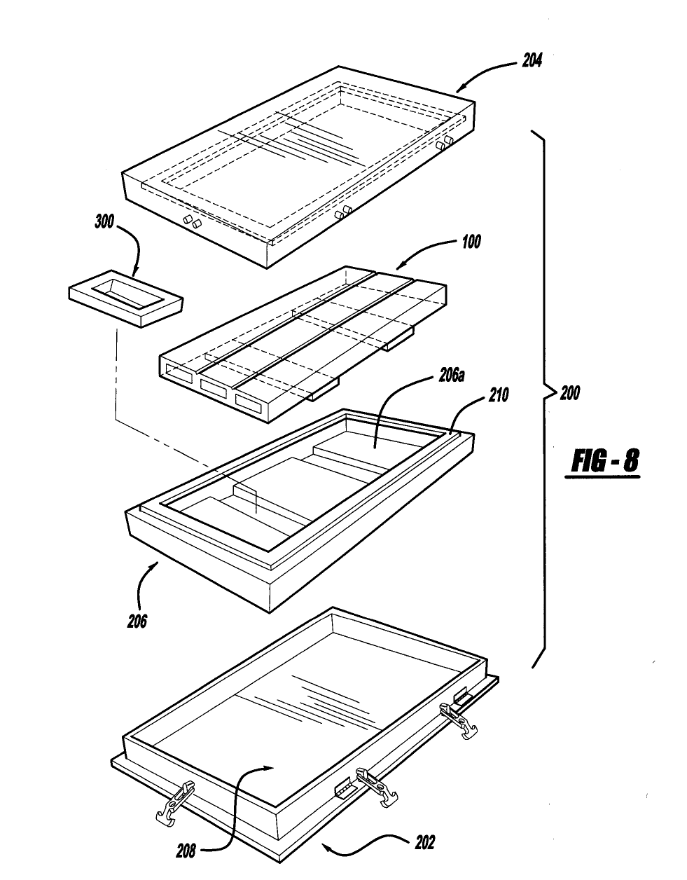

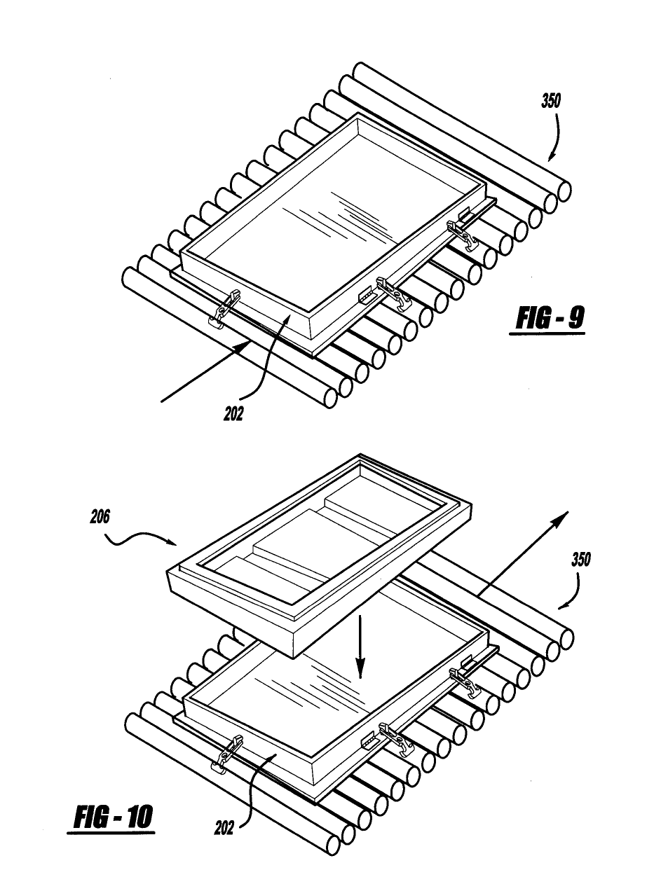

It is to be understood that one shutter assembly 10 according to the subject invention is a single shutter 20. That is, one shutter assembly 10 is one left side shutter 20 or one right side shutter 20 such that two shutter assemblies 10 are preferred. For example, with specific reference to FIGS. 5-7, each shutter assembly 10 has a top 22, a bottom 24 and two sides 26a, 26b, respectively, extending between the top 22 and bottom 24.

The shutter assembly 10 includes a foam insert or core 100 that is completely or at least substantially completely enveloped or surrounded by a cementitious shell or coating 102. Additionally, various portions of the cementitious shell 102 can be permitted to infiltrate through various crevices, apertures, or spaces formed in the foam core 100, e.g., so as to form reinforcement or rib members 104 at various locations within the shutter assembly 10.

In accordance with one aspect of the present invention, the cementitious shell 102 is formed from a cementitious or cement slurry. The slurry can include hydraulic cement including, but not limited to, Portland, sorrel, slag, fly ash, or calcium alumina cement. Additionally, the cement can include a calcium sulfate alpha hemihydrate or calcium sulfate beta hemihydrate. The slurry can also utilize natural, synthetic, or chemically modified beta gypsum or alpha gypsum cement. The cementitious slurry preferably includes gypsum cement and a sufficient amount of water added thereto to produce a slurry having the desired consistency, i.e., not too dry nor not too watery.

Gypsum is a naturally occurring mineral, calcium sulfate dihydrate, CaSO₄.2H₂O (unless otherwise indicated, hereafter, “gypsum” will refer to the dihydrate form of calcium sulfate). After being mined, the raw gypsum is thermally processed to form a settable calcium sulfate, which can be anhydrous, but more typically is the hemihydrate, CaSO₄.1/2H₂O. For the familiar end uses, the settable calcium sulfate reacts with water to solidify by forming the dihydrate (gypsum). The hemihydrate has two recognized morphologies, alpha and beta hemihydrate. These are selected for various applications based on their physical properties. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention, either or both of the alpha or beta forms can be used, depending on the mechanical performance required. The beta form generates less dense microstructures and is preferred for low density products. Alpha hemihydrate could be substituted for beta hemihydrate to increase strength and density or they could be combined to adjust the properties.

The cementitious slurry can also include other additives. The additives can include, without limitation, accelerators and retarders to control setting times of slurry. Suitable accelerators include aluminum sulfate, potassium sulfate, and Terra Alba ground gypsum. Additional additives can be used to produce colored shutter assemblies 10, such dry powder metallic oxides such as iron and chrome oxide and pre-dispersed pigments used for coloring latex paints.

In accordance with one aspect of the present invention, a reinforcing material can also be disposed within the cementitious slurry, either prior to or after the introduction of the water thereto. The reinforcing material can include, without limitation, fibers, e.g., either chopped or continuous fibers, comprising at least one of polypropylene fibers, polyester fibers, glass fibers, and/or aromatic polyamide fibers. By way of a non-limiting example, the reinforcing material can include a combination of the fibers, such as the polypropylene fibers and the glass fibers or the polyester fibers and the glass fibers or a blend of the polypropylene fibers and the polyester fibers and the glass fibers. If included in the fiber composition, the aromatic polyamide fibers are formed from poly-paraphenylene terephthalamide, which is a nylon-like polymer commercially available as KEVLAR® from DuPont of Wilmington, Del. Of course, aromatic polyamide fibers other than KEVLAR® are also suitable for use in the fiber composition of the subject invention.

The cementitious slurry can then be mixed, either manually or automatically, so as to adequately combine the various ingredients thereof and optionally can also be agitated, e.g., by a vibrating table, to remove or lessen any air bubbles that formed in the cementitious slurry.

Referring to FIGS. 8-18, one illustrative system and method of forming the shutter assembly 10 of the present invention is shown as being formed in a selectively closable mold system 200. With specific reference to FIG. 8, the mold system 200 includes a lower or bottom mold surface portion 202 and an upper or top mold surface portion 204 that are selectively operable to come into and out of contact with one another. By way of a non-limiting example, the upper or top mold surface portion 204 can be hingedly attached to the lower or bottom mold surface portion 202, such that the upper or top mold surface portion 204 can rotate downwardly towards or upwardly away from the lower or bottom mold surface portion 202. Additionally, the mold system 200, and components thereof, can be operated either manually and/or automatically.

A mold surface member 206 is preferably disposed within a cavity 208 formed in the lower or bottom mold surface portion 202. Although the lower or bottom mold surface portion 202 is shown as being an open shell having a substantially rectangular configuration, the lower or bottom mold surface portion 202 can have any number of various configurations. The mold surface member 206 can be formed of any type of material, such as rigid or flexible materials; however, preferably the mold surface member 206 is formed from a suitably flexible material that, e.g., can be removed from the cavity 208. The face 206a of the mold surface member 206 is essentially a negative image of the desired front exterior surface shape of the shutter assembly 10. Additionally, the mold surface member 206 preferably includes a peripheral lip member 210 to aid in grasping the mold surface member 206, e.g., when it is desired to remove the mold surface member 206 from the cavity 208. The foam core or insert 100 and an optional hanger member 300 are shown for illustrative orientation purposes.

Because of the weights involved of the various components, as well as the cementitious slurry, a transport device, such as a conveyor system 350 (e.g., see FIG. 9), either manually or automatically operated, can be employed to guide the mold system 200 along during the manufacturing process, e.g., from an initial processing station, to a curing station, and finally to a product removal station. In this manner, many shutter assemblies can be produced sequentially and rapidly (e.g., in an assembly line process) without having to wait for each individual shutter assembly to be finally and completely manufactured.

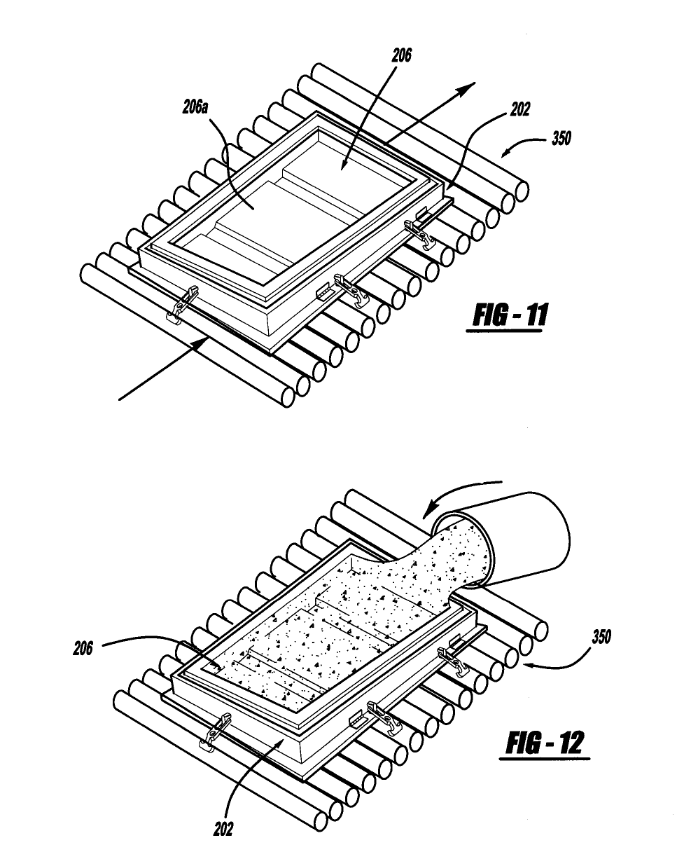

After the cementitious slurry has been prepared, as described above, the cementitious slurry, preferably when still wet, is then poured into the bottom mold surface portion 202, either manually or mechanically, such that it contacts and fills the mold surface member 206 to a desired depth or volume (e.g., see FIGS. 10-13). By way of a non-limiting example, the cementitious slurry is poured onto the mold surface member 206 until it reaches a depth (or volume) of about one-half way up the exterior wall of the mold surface member 206. However, it should be appreciated that either less than or more than this amount of the cementitious slurry can be used, e.g., depending on the specific application.

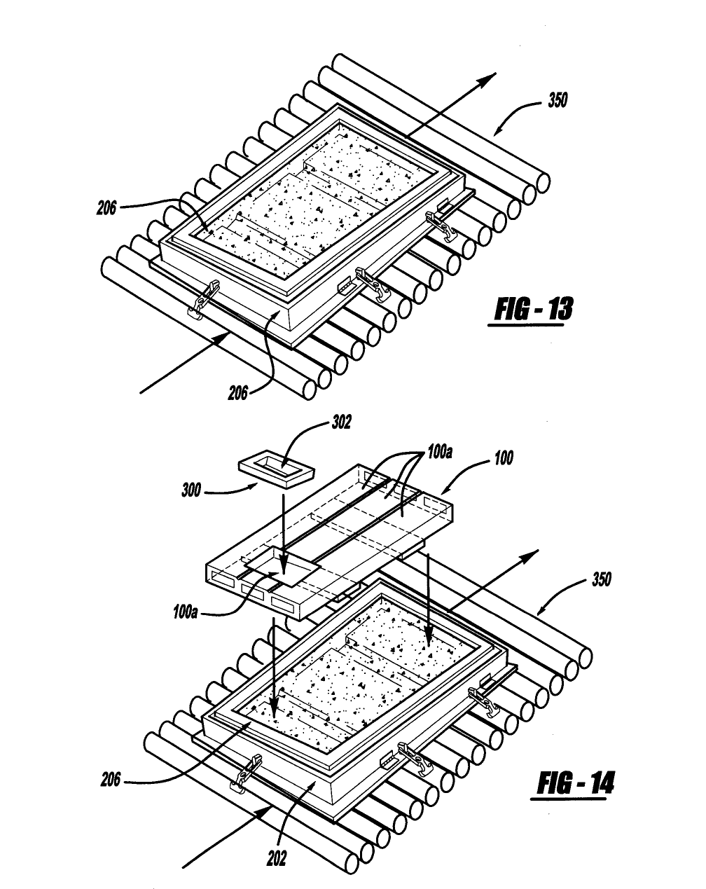

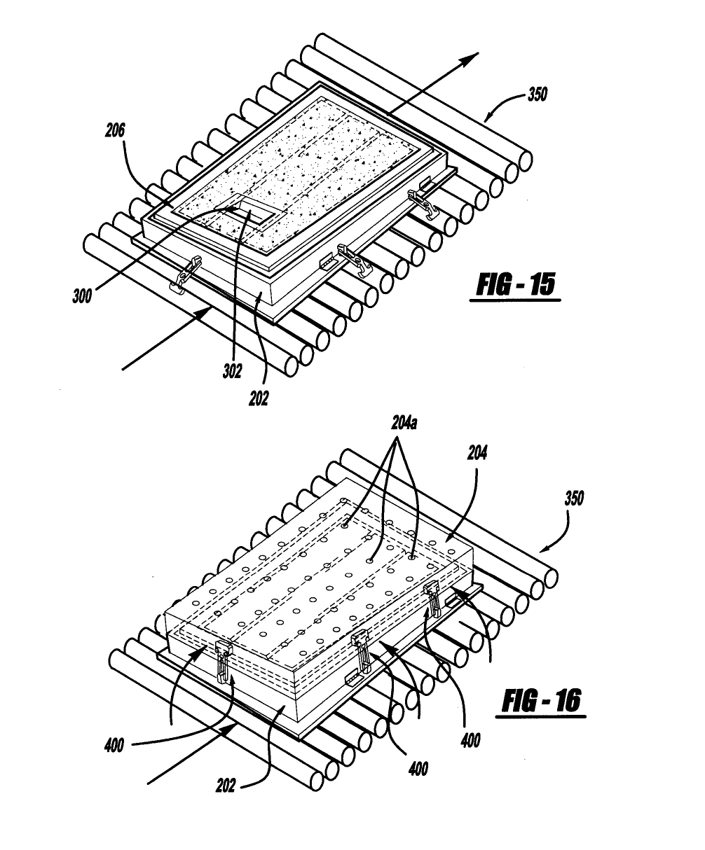

With specific reference to FIGS. 14 and 15, it should be noted that if an optional hanger member 300 is desired, it should be placed, in a proper orientation, on the mold surface member 206 prior to the introduction of any cementitious slurry therein. However, it should be appreciated that the hanger member 300 can also be placed on the mold surface member 206 after the introduction of any cementitious slurry therein.

The hanger member 300 can be used for mounting the shutter assembly 10 to the dwelling 12 instead of driving fasteners through the shutter assembly 10. The hanger member 300 includes an area defining a recess 302 that is operable to receive a bracket (not shown) or other mounting device mounted to the dwelling 12, thus obviating the need to drive fasteners through the shutter assembly 10, which could potentially damage the cementitious material, e.g., via cracking and/or the like. Additionally, the hanger member 300 can be designed to be disposed in a cutout portion 100a formed in the foam core or insert 100 itself, or alternatively, the foam core or insert 100 can be designed to only extend up to, but not past or above the level of the hanger member 300.

By way of a non-limiting example, the hanger member 300 can be temporarily attached to the upper or top mold surface portion 204, e.g., via a form fitting rubber plug (not shown) that prevents any cementitious slurry from seeping or leaking into the hanger member 300 (e.g., the recess 302) which is pushed into the cementitious slurry when the upper or top mold surface portion 204 is closed.

As noted, once a sufficient amount of the cementitious slurry is disposed onto the mold surface member 206, the foam core or insert 100 is then placed onto the cementitious slurry and is properly positioned in the mold in a desired orientation. The cementitious slurry initially penetrates through any crevices, apertures or spaces between adjacent portions of the foam core or insert 100, such as the crevices, apertures or spaces formed between the individual slat members 100a and in this manner forms the reinforcement or rib members 104 previously described. Optionally, a vibratory force can be applied to the mold system 200, e.g., to remove any residual air bubbles in the cementitious slurry, e.g., either before or after the foam core or insert 100 is placed therein.

Optionally, half of the cementitious slurry can be disposed onto the mold surface member 206, with the foam core or insert 100 being placed therein, with the remaining half of the cementitious slurry then being poured over the foam core or insert 100.

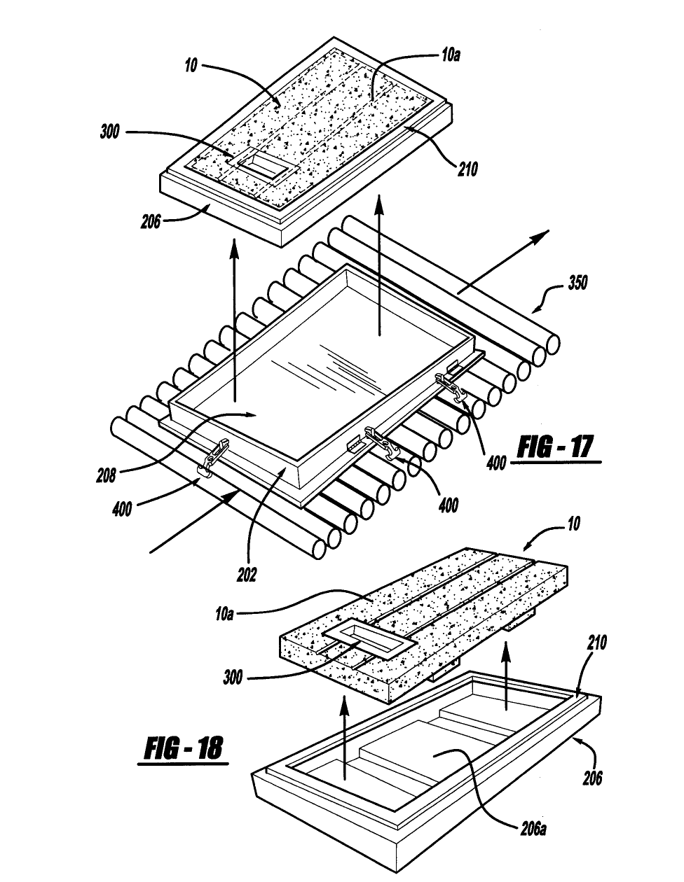

With specific reference to FIG. 16, because the foam core or insert 100 can have a tendency to float, the upper or top mold surface portion 204 is brought into contact with the lower or bottom mold surface portion 202 so as to keep the foam core or insert 100 submerged within the cementitious slurry. The upper or top mold surface portion 204 can be provided with an optional series of members 204a, e.g., protuberances, bumps, and/or the like, which project outwardly from the face of the upper or top mold surface portion 204 such that they contact, either constantly or intermittently, the foam core or insert 100 and keep the same from excessively floating upwardly out of the cementitious slurry.

In accordance with one aspect of the present invention, the upper or top mold surface portion 204 can be secured to the lower or bottom mold surface portion 202 with fastening devices 400 so as to prevent the upper or top mold surface portion 204 and the lower or bottom mold surface portion 202 from becoming inadvertently dislodged from one another. The cementitious slurry is then allowed to dry, harden or cure for a sufficient amount of time, which may depend, at least in part, on the specific composition of the cementitious slurry used. The mold system 200 can also be shuttled off of the conveyor system 350 and stored in a storage area (not shown) so that other shutter assemblies can be made in the interim.

With specific reference to FIGS. 17 and 18, once the cementitious slurry has sufficiently dried, hardened or cured, the shutter assembly 10 can then be removed from the mold system 200. By way of a non-limiting example, the fastening devices 400, if used, are disengaged so as to enable the upper or top mold surface portion 204 to be removed from the lower or bottom mold surface portion 202, thus exposing the rear face 10a of the shutter assembly 10. The mold surface member 206 can then be removed from the cavity 208 by grapping the peripheral lip member 210 and lifting the mold surface member 206 upwardly and out of the cavity 208. The mold surface member 206 is then removed from the shutter assembly 10 (hence the preference for a flexible mold surface member 206), thus exposing the finished product, which is preferably allowed to dry to a suitable extent, after which time it can then be used immediately or further processed, e.g., painted or otherwise treated.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for forming a molded component, comprising:
providing a bottom mold surface member;
charging an amount of a cementitious material onto the bottom mold surface member; and
disposing a foam member into the cementitious material such that the foam member is at least partially enveloped by the cementitious material.

2. The invention according to claim 1, further comprising providing an upper mold surface member operably associated with the bottom mold surface member.

3. The invention according to claim 2, wherein the upper mold surface member is selectively operable to cause the foam member to be at least partially submerged within the cementitious material.

4. The invention according to claim 2, wherein the upper mold surface member includes a surface portion having a plurality of protuberances formed thereon, wherein the protuberances are selectively operable to cause the foam member to be at least partially submerged within the cementitious material.

5. The invention according to claim 1, further comprising providing an insert selectively operable to be disposed within the bottom mold surface member, wherein the insert includes a surface configuration.

6. The invention according to claim 5, wherein the surface configuration is selectively operable to form a surface of a shutter.

7. The invention according to claim 5, wherein the component is selectively operable to be removed from the insert after the cementitious material has sufficiently cured.

8. The invention according to claim 1, wherein the component comprises a shutter.

9. The invention according to claim 1, wherein the foam member is completely enveloped by the cementitious material.

10. The invention according to claim 1, further comprising providing a hangar member disposed within the cementitious material.

11. The invention according to claim 1, wherein the foam member includes at least one opening formed therein such that the cementitious material is selectively operable to penetrate therethrough.

12. A molded component, comprising:
a foam member; and
a cementitious shell at least partially enveloping the foam member.

13. The invention according to claim 12, wherein the component comprises a shutter.

14. The invention according to claim 12, wherein the foam member is completely enveloped by the cementitious material.

15. The invention according to claim 12, further comprising a hangar member disposed within the cementitious material.

16. The invention according to claim 12, wherein the foam member includes at least one opening formed therein such that the cementitious material is selectively operable to penetrate therethrough.

17. The invention according to claim 12, wherein the component is formed by:
charging an amount of the cementitious material onto a bottom mold surface member;
disposing the foam member into the cementitious material such that the foam member is at least partially enveloped by the cementitious material; and
allowing the cementitious material to cure for a sufficient period of time.

18. The invention according to claim 17, further comprising an upper mold surface member operably associated with the bottom mold surface member.

19. The invention according to claim 18, wherein the upper mold surface member is selectively operable to cause the foam member to be at least partially submerged within the cementitious material.

20. The invention according to claim 18, wherein the upper mold surface member includes a surface portion having a plurality of protuberances formed thereon, wherein the protuberances are selectively operable to cause the foam member to be at least partially submerged within the cementitious material.

21. The invention according to claim 17, further comprising an insert selectively operable to be disposed within the bottom mold surface member, wherein the insert includes a surface configuration.

22. The invention according to claim 21, wherein the surface configuration is selectively operable to form a surface of a shutter.

23. The invention according to claim 21, wherein the component is selectively operable to be removed from the insert after the cementitious material has sufficiently cured.

24. A system for forming a molded component, comprising:
a bottom mold surface member;
wherein an amount of a cementitious material charged onto the bottom mold surface member;
wherein a foam member is disposed into the cementitious material such that the foam member is at least partially enveloped by the cementitious material.

25. The invention according to claim 24, further comprising an upper mold surface member operably associated with the bottom mold surface member.

26. The invention according to claim 25, wherein the upper mold surface member is selectively operable to cause the foam member to be at least partially submerged within the cementitious material.

27. The invention according to claim 25, wherein the upper mold surface member includes a surface portion having a plurality of protuberances formed thereon, wherein the protuberances are selectively operable to cause the foam member to be at least partially submerged within the cementitious material.

28. The invention according to claim 24, further comprising an insert selectively operable to be disposed within the bottom mold surface member, wherein the insert includes a surface configuration.

29. The invention according to claim 28, wherein the surface configuration is selectively operable to form a surface of a shutter.

30. The invention according to claim 28, wherein the component is selectively operable to be removed from the insert after the cementitious material has sufficiently cured.

31. The invention according to claim 24, wherein the component comprises a shutter.

32. The invention according to claim 24, wherein the foam member is completely enveloped by the cementitious material.

33. The invention according to claim 24, further comprising a hangar member disposed within the cementitious material.

34. The invention according to claim 24, wherein the foam member includes at least one opening formed therein such that the cementitious material is selectively operable to penetrate therethrough.
